(19) United States
(12) Patent Application Publication
(10) Pub. No.: US 2010/0303971 A1
(43) Pub. Date: Dec. 2, 2010

(54) PRODUCING FOAM AND DISPERSING CREAMER AND FLAVOR THROUGH PACKAGING

(75) Inventors: Frederick G. Melms, JR., Westminster, CO (US); Mary B. Malone, Broomfield, CO (US)

Correspondence Address: BAKER BOTTS L.L.P., 2001 ROSS AVENUE, SUITE 600, DALLAS, TX, 75201-2980, US

(73) Assignee: WhiteWave Services, Inc., Dallas, TX (US)

(21) Appl. No.: 12/791,294

(22) Filed: Jun. 1, 2010

Related U.S. Application Data
(60) Provisional application No. 61/183,369, filed on Jun. 2, 2009.

(51) Int. Cl. B65D 83/14; A23P 1/16; A23C 13/00; B67D 7/74

(52) U.S. Cl. 426/116; 426/120; 222/129

(57) ABSTRACT

According to one embodiment, a pressurized package dispenses a formula comprising a foaming agent into a liquid. The internal pressure of the package generates turbulence that causes some of the formula to disperse throughout the liquid and some of the formula to form a foam on a surface of the liquid.

### RELATED APPLICATION

This application claims the benefit of priority under 35 U.S.C. §119(e) of U.S. Provisional Application Ser. No. 61/183,369, filed Jun. 2, 2009, and entitled “PRODUCING A CREAMER AND FOAMER THROUGH PRESSURIZED PACKAGING.”

### TECHNICAL FIELD

This disclosure relates in general to packaging and, more particularly, to producing a foam and dispersing creamer and/or flavor through packaging.

### BACKGROUND

Coffee beverages may be made by adding foamed milk to espresso. Different amounts of milk may be added to espresso to form various types of coffee beverages such as cappuccinos, café lattes, café macchiatos, or mochas. Traditional coffee machines may prepare milk foam by submerging a steam wand in milk. Traditional coffee machines, however, may not be well-suited for in-home use due to cost, size, and/or complexity.

### SUMMARY

According to one embodiment, a pressurized package dispenses a formula comprising a foaming agent into a liquid. The internal pressure of the package generates turbulence that causes some of the formula to disperse throughout the liquid and some of the formula to form a foam on a surface of the liquid.

Embodiments of the disclosure may provide numerous technical advantages. According to one embodiment, the creamer and foamer formula may cream coffee while also generating a head of foam on the surface of the beverage. The coffee may be creamed without requiring subsequent stirring. Additionally, the foam may have a strong structure that may be maintained when exposed to hot coffee. The creamer and foamer formula may reduce problems associated with known coffee additives such as weak creaming, weak foaming, off-flavor, potential to cause splashing, requirements for significant headspace above the coffee in the cup, excessive cooling, and/or unsanitary packaging. According to one embodiment, the creamer and foamer formula may be used to prepare a cappuccino-type beverage in the home. For example, the creamer and foamer formula may be portable, easy to use, safe, and/or low cost.

Some, none, or all embodiments may benefit from the below described advantages. Other technical advantages will be apparent to one of skill in the art.

### BRIEF DESCRIPTION OF THE DRAWINGS

A more complete understanding of embodiments of the disclosure will be apparent from the detailed description taken in conjunction with the accompanying drawings in which:

FIG. 1a illustrates an example of a system for generating a creamed liquid and a foam;

FIG. 1b illustrates an example of a creamed liquid and a foam that has been generated using the system of FIG. 1a;

FIG. 2a illustrates an example of a package that may dispense a formula at a pressure that causes the formula to cream and foam;

FIG. 2b illustrates an example of a valve system for dispensing the creamer and foamer formula from the package;

FIG. 2c illustrates an example of an alternative actuating system for dispensing a formula from the package;

FIG. 2d illustrates an example of a base for the package;

FIGS. 3a-3c illustrate examples of tamper evidence for the package;

FIGS. 4a-4e illustrate examples of lock-out features for the package;

FIG. 5a illustrates an example of a package comprising separate chambers for dispensing a creamer and a foam; and

FIG. 5b illustrates an example of a package comprising independent dispensers for dispensing a creamer and a foam.

### DETAILED DESCRIPTION

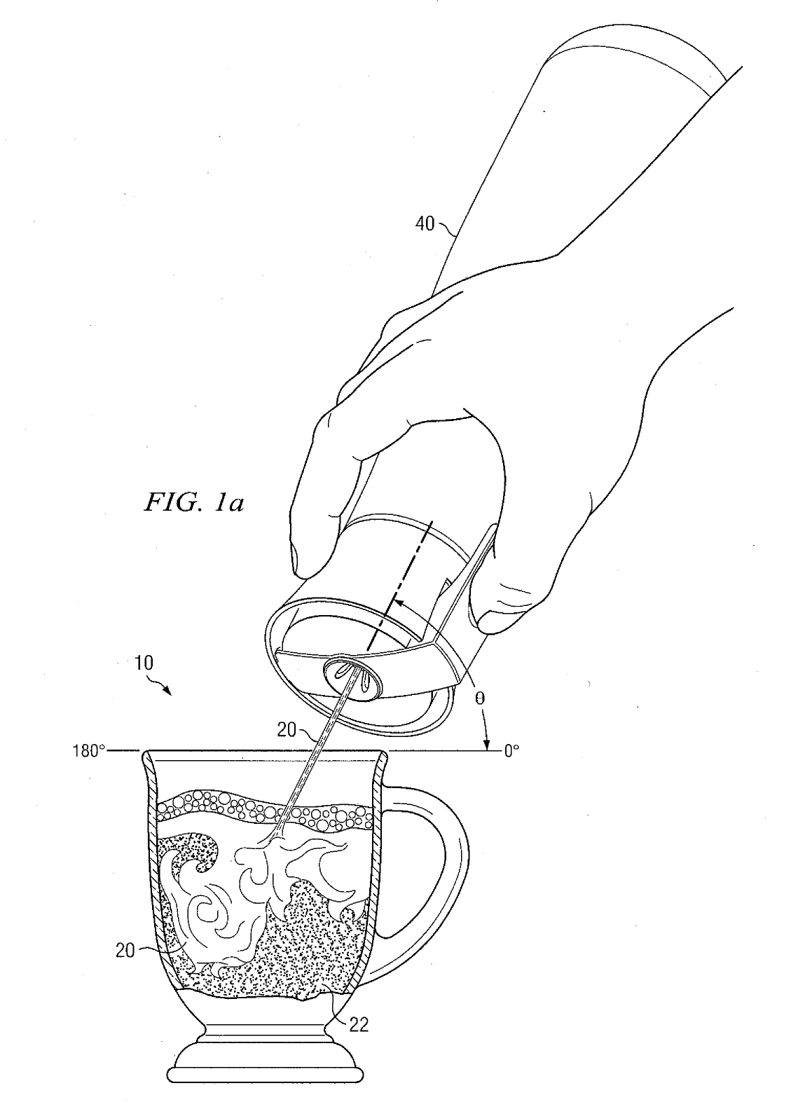

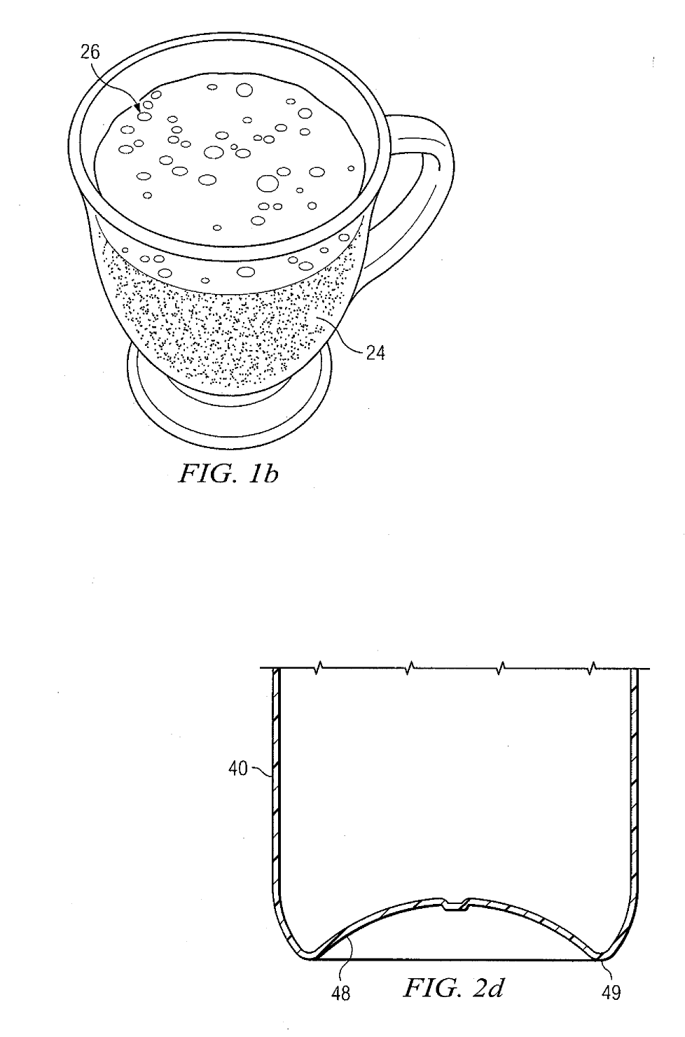

Embodiments of the present invention and its advantages are best understood by referring to FIGS. 1 to 3 of the drawings, like numerals being used for like and corresponding parts of the various drawings. Coffee beverages may be made by adding foamed milk to espresso. Different amounts of milk may be added to espresso to form various types of coffee beverages such as cappuccinos, café lattes, café macchiatos, or mochas. Traditional coffee machines may prepare milk foam by submerging a steam wand in milk. Traditional coffee machines, however, may not be well-suited for in-home use due to cost, size, and/or complexity. Additionally, components that come in contact with food, such as steam wands, may require frequent cleaning for sanitary purposes and to avoid food build-up that may interfere with the proper functioning of the component. Alternatives to traditional coffee machines may be unsuitable for making cappuccino-type beverages. For example, known creamers, such as milk, milk alternatives (e.g, soy milk, almond milk, coconut milk), half and half, or non-dairy creamers may be unable to provide a stable foam. Known toppings, such as aerosol or packaged whipped cream, may float on the top of coffee without creaming the coffee and/or may dissolve when exposed to a hot beverage. Accordingly, it may be desirable to have an in-home formula that produces both cream and foam reminiscent of a coffeehouse cappuccino or latte.

FIG. 1a illustrates an example of a system 10 for generating a creamed liquid and a foam. A creamed liquid may be characterized as a first liquid, such as a creamer and/or a flavor, dispersed throughout a second liquid. As an example, a creamed liquid may include milk or cream dispersed throughout coffee. The creamer may be any suitable liquid, and it need not include cream. In some embodiments, the creamer may be non-dairy. A foam may be characterized as gas bubbles separated by a thin film and dispersed in a liquid or solid. For example, gas bubbles may be dispersed in milk, half & half, or non-dairy creamer. Foam may generally sit on the surface of a liquid, such as when foamed milk sits on the surface of coffee or creamed coffee.

According to some embodiments, the system 10 may comprise a formula 20 and a package 40. In some embodiments, the composition of the formula 20 and the pressure at which it is dispensed from the package 40 may be selected such that the formula 20 acts as a creamer and a foamer when applied to a liquid 22. For example, a stream of the formula 20 may create turbulence when dispensed into the liquid 22 that causes creaming and foaming. In some embodiments, the formula 20 may be a food formula, such as a dairy or non-dairy creamer and/or a flavor, and the liquid 22 may be a beverage, such as coffee.

FIG. 1b illustrates an example of a creamed liquid 24 and a foam 26 that has been generated using the system of FIG. 1a. In some embodiments, the package 40 may apply the formula 20 at a pressure that mixes the formula 20 and the liquid 22 to form the creamed liquid 24 without destroying the foam 26. The proper amount of thrust may cause an insulating barrier to develop between the creamed liquid 24 and the foam 26. The insulating barrier may allow the foam 26 to accumulate to form a head on the surface of the creamed liquid 24. In some embodiments, the foam 26 may have a strong enough structure to be maintained when exposed to hot coffee. In some embodiments, the foam 26 may be velvety and wet, such as when the foam is used in a cappuccino-type beverage. As an example, the foam may have an overrun of 10 to 600%, an air cell size of 1 to 250 micrometers, and a stability of 1 to 30 minutes.

The foam 26 may comprise two-phases, such as gas bubbles and a liquid. A stable foam 26 may have a low surface tension so that bubbles may contain a suitable amount of air to prevent the bubbles from contracting. Additionally, a stable foam 26 may have a low vapor pressure which may reduce the evaporation and rupturing of the bubble film. Producing a stable foam 26 may require gelation to solidify the bubble film and/or insolubilization to prevent the bubble film from dissolving. Gelation and/or insolubilization may trap the gas within the bubble and increase the rigidity of the foam 26. In some embodiments, the foam 26 generated by the system 10 may be relatively resistant to typical sources of foam instability. For example, the foam may be relatively resistant to Ostwald Ripening (the diffusion of gas from smaller bubbles to the atmosphere or to larger bubbles), drainage of liquid from and through the foam layer due to gravity, and/or the coalescence of bubbles due to instability of the bubble film.

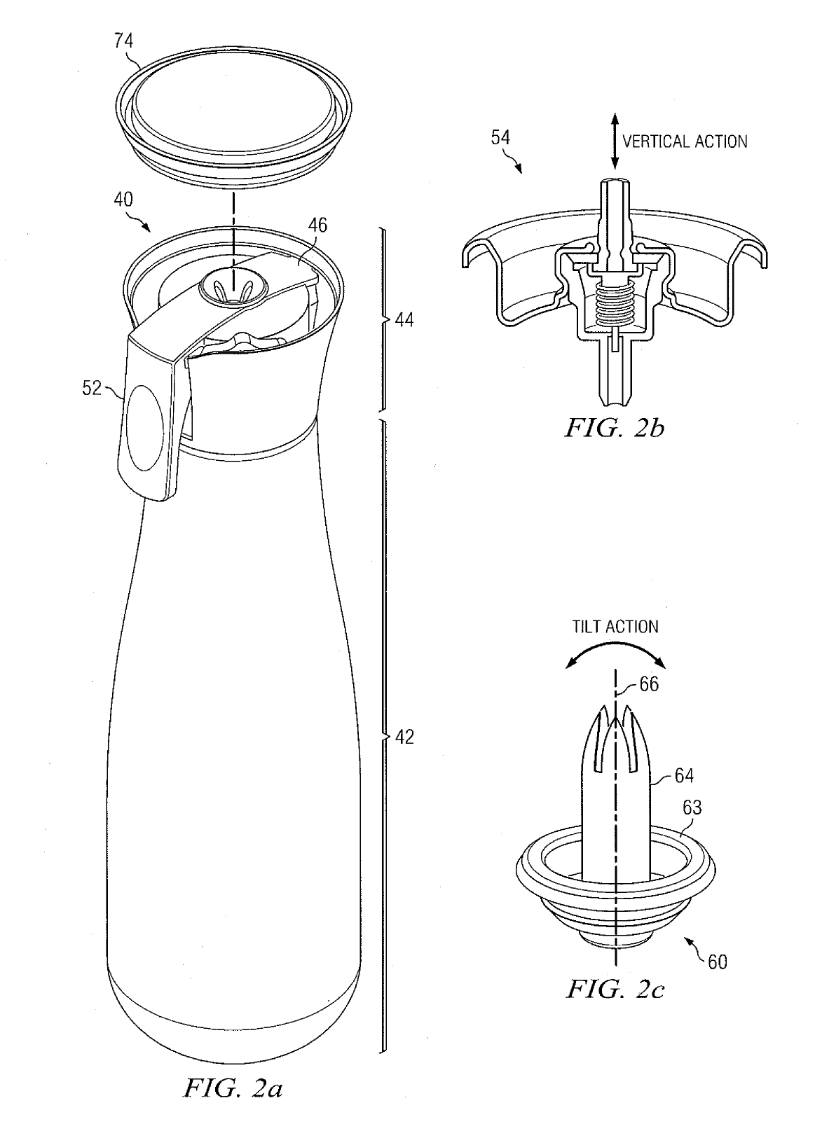

FIG. 2a illustrates an example of a package 40 that may dispense a formula at a pressure that causes the formula to cream and foam. The package 40 may comprise a container member 42 and a top member 44. The container member 42 may form a chamber for the storage and containment of the formula. The top member 44 may be coupled to the container member 42 and may include an actuator 52 operable to evacuate the package 40 when positively engaged.

According to some embodiments, the package 40 may be an aerosol bottle configured to dispense the formula by controlling the internal pressure of the package 40. The propellant may be any propellant suitable for selectively applying pressure to release the formula from the package 40. Examples of propellants include nitrous oxide, nitrogen, carbon dioxide, and combinations thereof. In some embodiments, the formula and propellant may be infused to form a formula/propellant emulsion. Infusing the propellant in the formula may aid in the formation of foam when the formula is dispensed from the package 40. For example, the gas from within the formula/propellant emulsion may expand as it is released, thereby forming the foam. In some embodiments, a portion of the foam that exits the package 40 may be generally converted to a liquid form upon exposure to a liquid, such as a beverage, to cream the liquid. In some embodiments, propellants of differing solubility may be combined, for example, the first propellant may create an emulsion with the formula and thereby expand the formula into foam when released from the package and the second propellant may function primarily to expel the formula out of the container.

The package 40 may comprise any suitable mechanical means for dispensing the formula from the package, such as a 360 degree actuated valve system, a bag-on-valve system, and/or a valve system configured with or without a dip tube. In some embodiments, the valve system, combined with an actuator, may be designed to evacuate the formula when the package 40 is oriented such that the opening from which the food formula exits the package points at an angle θ substantially horizontal to or downward toward the liquid, as shown in FIG. 1a. For example, the angle θ may have a value in the range of approximately 0 to 180 degrees, plus or minus approximately 15 degrees. Evacuating the formula downward into the liquid may facilitate creaming and foaming.

FIG. 2a, together with FIG. 2b, illustrates an example of an aerosol system for dispensing the creamer and foamer formula from the package 40. The aerosol system may comprise an actuator 52, a valve 54, and a formula/propellant emulsion (not shown). Any suitable valve 54 may be used, such as a vertical action valve or a tilt action valve. In some embodiments, the aerosol system may be incorporated into the base of the package 40 (not shown) or the top member of the package.

According to some embodiments, the actuator 52 and the valve 54 of the aerosol system 50 may be used to control the internal pressure of the package 40. In some embodiments, the actuator 52 may allow a user to operate the valve 54. For example, the valve 54 may be activated (opened) when the user presses the actuator 52. When the valve 54 is activated, the internal pressure of the package 40 may decrease causing the propellant to expand and push the formula from the package 40. In some embodiments, the actuator 52 may have a narrow channel running through it. The channel may run from an inlet near the bottom of the actuator to its top. In some embodiments, the valve may comprise a spring that may push the actuator 52 up so the channel inlet is blocked by a tight seal. When the actuator 52 is positively engaged (e.g., by pressing, squeezing, or applying force), the inlet may slide below the seal, opening a passage from the inside of the package 40 to the outside. When the actuator 52 is engaged to open the valve 54, the propellant gas moves from a high pressure environment inside the bottle to a lower pressure state which exists external to the bottle. This process forces the emulsified formula out of the bottle. The gas expands and subsequently forms a foam structure.

In some embodiments, the formula may travel through a stem portion of the valve 54 in order to evacuate the package. The stem may comprise a straight shape or an angled shape. The angled shape may allow a consumer to better control the direction of the formula being evacuated from the package. However, the angled shape may tend to cause residual amounts of the formula to collect and solidify in and around the stem. Solidified particles may prevent the formula from flowing smoothly out of the package 40. A cap or other mechanism may be used to keep air from reaching the residual formula so that the formula does not solidify within the stem. In some embodiments, the formula may flow through a portion of the actuator after it leaves the stem portion of the valve 54. In some embodiments, a lock-out feature to prevent dispensing may be combined with the cap or mechanism used to keep air from reaching the residual formula.

In some embodiments, the internal pressure of the package 40 may be selected to allow the formula/propellant emulsion to be released at a rate that is high enough to cause the creamer to mix with the coffee, but low enough to develop and maintain the foam structure and minimize splashing. In some embodiments, the pressure may be selected so that the creaming and foaming are generated simultaneously. That is, the cream and foam may be generated without an additional step such as stirring or heating. The amount of pressure needed to produce the creamer and foamer may vary. For example, the package 40 may be scaled to hold different amounts of food formula. In some embodiments, the package 40 may have a fill capacity of 1-40 fluid ounces of food formula, such as 10-16 fluid ounces. The internal pressure for causing the formula to cream and foam may vary depending on the fill capacity of the package. In some embodiments, the package may have an internal pressure of 30 to 160 psi, such as 50 to 140 psi, for example, 70 to 120 psi. The internal pressure may be measured at room temperature with the valve closed.

The package 40 may be made of any suitable material, including metal, such as tin plate, steel, or aluminum, or a polymer-based material, such as polyethylene terephthalate (PET), polyethylene naphthalate (PEN), or other plastics. Traditional aerosol systems may use propellants such as isobutane or isoproponal, which may be flammable under certain conditions. Accordingly, traditional aerosol systems may require metal packaging to prevent the product from catching fire. Embodiments of the present disclosure may be designed to reduce flammability, thereby allowing for the combination of an aerosol system and polymer-based packaging. For example, the propellant(s) may be selected from gases that are non-flammable at room temperature, such as nitrous oxide, nitrogen, or carbon dioxide. As another example, the package 40 may hold a refrigerated formula, such as a dairy or non-dairy food formula. Refrigerating may maintain the aerosol system at a temperature where the propellant is unlikely to catch fire. In some embodiments, the polymer-based package may be manufactured using injection molding and blow molding techniques, and the valve may be attached to the bottle by crimping.

In some embodiments, the package may be decorated with a “shrink sleeve,” a pressure-sensitive, heat-transfer label, or other like means that conveys a marketing/branding message, nutritional information, ingredients statement, legal & selling communication, such as formula weight and barcode/universal formula code, and instructions on how to use the product. The consumer may initiate use of the product by first reviewing the instructions on the package. The user may initially intrude the tamper evidence of the package to open for use. The tamper evidence may indicate if the package has been previously opened or tampered with.

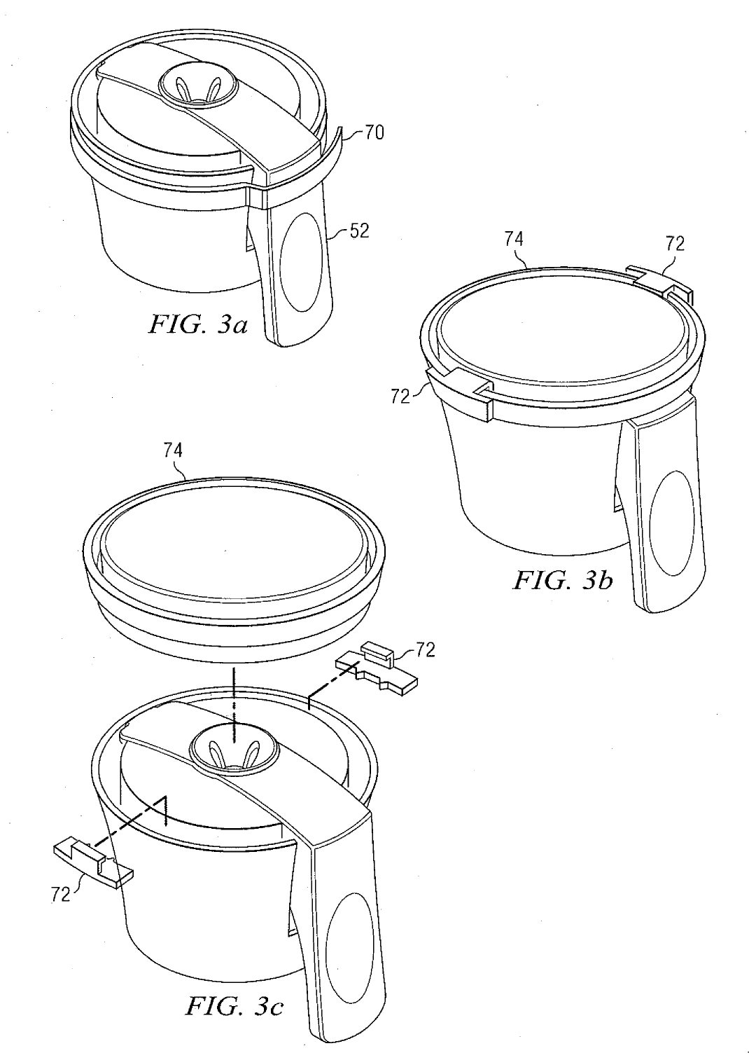

Any suitable tamper evidence may be used, for example, a peal-off seal, shrink wrap, a tear-off ring, or other tamper evidence. FIG. 3a illustrates an example of a tear-off ring 70 anchored to an actuator 52. Anchoring the tear-off ring 70 may prevent the cap from spinning when the tear-off ring is pulled from a non-threaded fit.

In some embodiments, tamper evidence may comprise embedded break-away tabs. For example, FIG. 3b illustrates break-away tabs 72 hold an overcap 74 in place prior to opening the product. FIG. 3c illustrates break-away tabs 72 removed from the package and the overcap released. In some embodiments, the overcap 74 may be put back into place by the user, however, the break-away tabs 72 remain broken off to indicate tamper evidence. Any suitable number of break-away tabs 72 may be used, such as two break-away tabs 72, and the tabs may be evenly spaced along the perimeter of the overcap. In some embodiments, the break-away tabs 72 may traverse only a portion of the perimeter of the overcap, such as less than one-half of the perimeter, for example, less than one-fourth of the perimeter. Thus, the break-away tabs 72 may require less processing and materials than other tamper evidence mechanisms, such as tear-off rings and shrink wrap, and may reduce costs.

After removing the tamper evidence, use of the package may be characterized by removing the closure cap (e.g., a flip cap or overcap) and pressing the actuator until a customized level of the creamer and foamer formula has been dispensed into the coffee. Once complete, the closure cap may be flipped closed or placed back into position and the product may be returned to the refrigerator. For subsequent use, the user may repeat the process above, but without having to deactivate the tamper evidence functionality.

In some embodiments, the package may include a lock-out feature. When locked, the lock-out feature may prevent the actuator from being actuated. Thus, accidental evacuation of the formula may be prevented. Additionally, the lock-out feature may prevent the propellant from seeping out of the package. Accordingly, a ratio of propellant to formula suitable to yield creaming and foaming may be maintained.

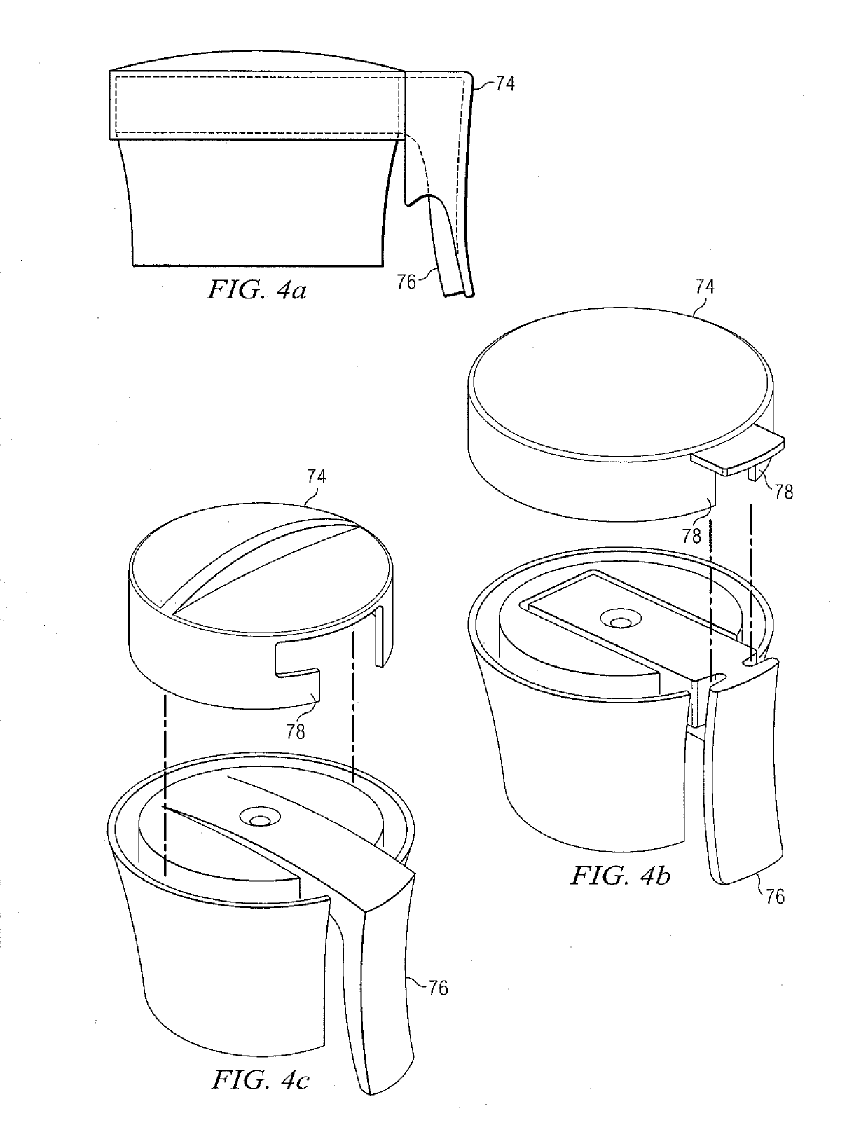

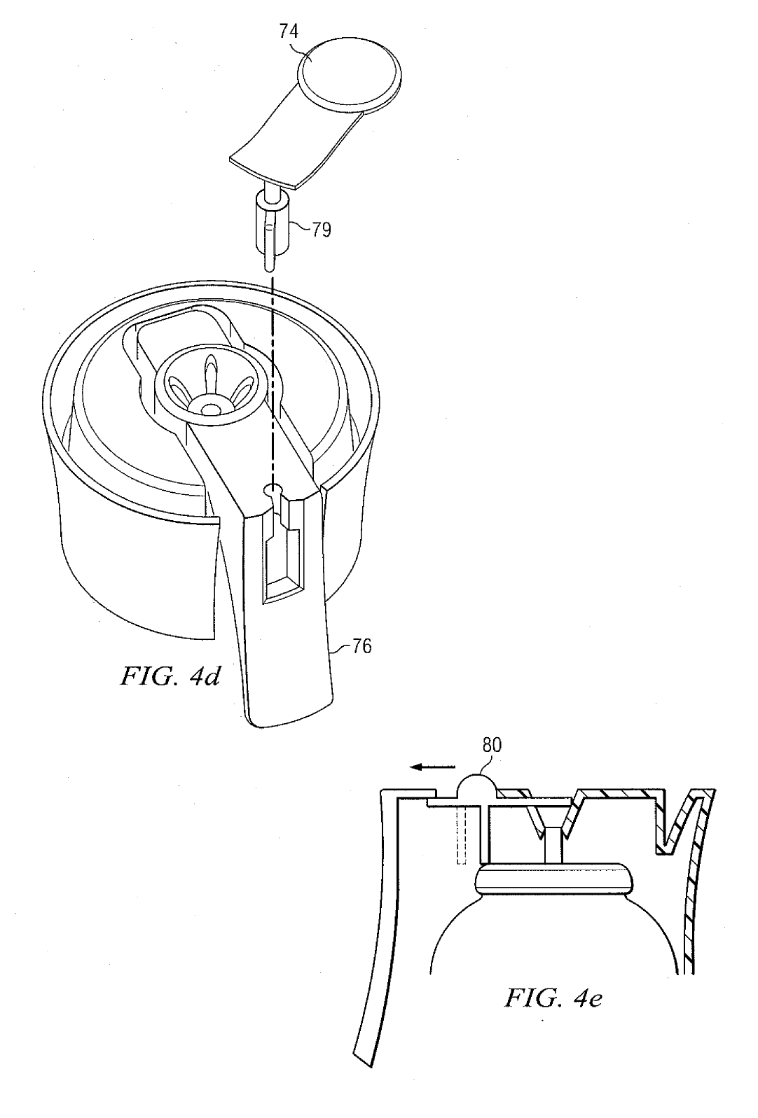

FIGS. 4a-4e illustrate examples of lock-out features for a lever-shaped actuator. The lever includes a handle that projects from the package that may be squeezed or pressed to dispense a substantially continuous flow of a formula-propellant emulsion from an aerosol valve. FIGS. 4a-4c illustrate examples of lock-out features that may prevent the lever from being pressed. For example, FIG. 4a illustrates an overcap 74 that fits over a lever 76 and blocks access to the lever 76. FIGS. 4b-4c illustrate overcaps 74 that introduce a barrier 78 along a pivot axis of the lever 76 to prevent the lever 76 from actuating the package. The package may be locked by snapping and/or rotating the overcap 74 into a locked position. FIG. 4d illustrates a lever 76 that includes a toggle switch 79 for controlling the overcap 74. The package may be locked by adjusting the toggle switch 79 so that the overcap 74 covers the package opening. FIG. 4e illustrates a lock-out feature that is partially internal to the package. The lock-out feature may include an external controller, such as a tab 80, for the user to control locking and unlocking. For example, a barrier may block an aperture through which the formula is released in order to lock the package.

According to some embodiments, the formula may be packaged in the package according to a typical aerosol filling process. For example, the process may be sequenced as follows: 1) Depalletization of bottles, 2) Cleaning of bottles, 3) Decoration of bottles, 4) Filling of bottles, 5) Valve application via crimping, 6) Gassing/shaking operation, 7) Check-weighing, 8) Actuator/closure cap application, 9) Tray forming and filling, 10) Shrink bundling, 11) Palletization, 12) Unitization and unit load labeling. In some embodiments, the food formula is infused with the propellant during filling on a gasser/shaker system to create an emulsion within the packaging system.

FIG. 2c illustrates an example of an alternate actuating system 60 for a package, such as the package 40 of FIG. 2a. In some embodiments, the package may generally comprise the same packaging components and filling methods previously described, except the actuating system 60 may be used to dispense the formula. The actuating system 60 may include a system base 62 and a stem 64. The stem 64 may have a central axis 66, which may be substantially centered in the system base 62. In some embodiments, the formula may be dispensed by tilting the stem 64 away from a center of the system base 62. The actuating system may have a custom closure cap (not shown), such as an overcap, that may prevent accidental evacuation of product from the package and may include tamper evidence. In some embodiments, the closure cap may serve as base for the package to rest on throughout its life cycle.

The actuating system 60 may dispense any suitable formula. In some embodiments, the formula may include a known food formula, such as whipping cream (including full fat and/or low fat varieties). Known whipping cream formulas may include whipped topping formulas, such as the whipped topping formulas that may typically be packaged in metal cans. In some embodiments, the package including the actuating system 60 may provide a marketing and/or cost advantage for aerosol whipping cream applications. For example, a plastic package for dispensing whipping cream may provide marketing and/or cost advantages.

FIG. 2d illustrates an example of a base for the package 40. In some embodiments, the base may comprise a pushed up area 48 that generally curves inward toward a middle region of the package 40, such as a curve of a champagne style base. The base may include a standing ring 49 operable to contact a support surface upon which the package 40 may be placed (e.g., a shelf or a table). In some embodiments, the diameter of the standing ring 49 may be greater than or equal to approximately 80% of the diameter of the package 40. In some embodiments, the diameter of the standing ring 49 may be selected to increase the stability of the package 40, which may be a PET package or other suitable package.

TABLES 1 and 2 illustrate examples of the composition of the formula that may be dispensed from a package, such as the package 40 of FIG. 2a, to cream and foam a liquid. In some embodiments, the formula may be a food formula. The food formula may have a dairy base, such as milk or cream (including heavy whipped cream and light whipped cream), or a non-dairy base, such as water and/or oil. Any suitable fat content may be used, including, but not limited to, non-fat and reduced fat formulations. The food formula may be used to flavor cold, hot, or iced beverages, such as coffee, tea, hot chocolate, or any other beverage.

According to some embodiments, the formula may include one or more of: a fat, a protein, an emulsifier, a stabilizer, a salt, a sweetener, an antioxidant, a color, a bulking agent, flavor, water, milk, and cream. The fat may be dairy based, such as butterfat, or non-dairy based, such as vegetable (or nut) oil. Any suitable protein may be used, such as sodium caseinate, nonfat dry milk, whole milk powder, soy protein, whey protein, and/or wheat protein.

In some embodiments, the formula may include one or more foaming agents for creating and maintaining a head of foam. The foaming agents may include proteins, emulsifiers, stabilizers, bulking agents, or a combination. The types and amounts of the foaming agents may be varied to generate a desired set of foam properties, such as volume, stability, softness or rigidity, thickening, binding, and/or moisture retention. Additionally, certain foaming agents may be selected to generate a desired set of overall formula properties that may not be specific to the foam. As an example, some emulsifiers/stabilizers may be incorporated to maintain overall product stability. Examples of emulsifiers include Glycerin Fatty Acid Esters, Acetic Acid Esters of Mono and Diglycerides, Lactic Acid Esters of Mono and Diglycerides, Citric Acid Esters of Mono and Diglycerides, Succinic Acid Esters of Mono and Diglycerides, Diacetyl Tartaric Acid Esters of Mono and Diglycerides, Polyglycerol Esters of Fatty Acids, Polyglycerol Polyricinoleate, Sorbitan Esters of Fatty Acids, Propylene Glycol Esters of Fatty Acids, Sucrose Esters of Fatty Acids, Calcium Stearoyl Lactylate, Lecithin, Sodium Stearoyl Lactylate, Mono and Diglycerides, or a combination. Examples of stabilizers include Cellulose Gum, Agar-agar, Carrageenan, Gellan Gum, Guar Gum, Konjac, Hydroxypropyl cellulose, Methylcellulose and Hydroxypropyl cellulose, Xanthan Gum, Gum Arabic, Starch, Pectin, Gelatin, Propylene Glycol Alginate, or a combination. In some embodiments, the stabilizers may have a gel form, such as cellulose gel. Examples of bulking agents include corn syrup, corn syrup solids, maltodextrin, and dextrose.

In some embodiments, the formula may include one or more flavoring agents that may affect the taste of the formula. The flavoring agents may include salt, sweetener, flavor, and/or water. The salt may be common salt and/or buffering salt. Common salt may be used as a preservative and/or a seasoning. Buffering salt may be used to maintain a suitable pH value, such as when the formula is added to an acidic liquid like coffee. Buffering salt may improve the colloidal dispersiblity (uniform distribution) of proteins and prevent protein coagulation (curdling). In some embodiments, sweeteners may sweeten the taste of the formula. Examples of sweeteners include sugars and sugar alcohols, such as sucrose, fructose, dextrose, maltose, lactose, high fructose corn syrup, corn syrup solids, invert sugar, agave, and sorbitol, or a non-nutritive sweetener, or a combination. In some embodiments, flavor may distinguish the taste of the formula. Any suitable flavor may be used, such as vanilla, hazelnut, amaretto, Irish créme, cinnamon, butter pecan, chocolate, or any other flavor. In some embodiments, water may be used to dilute the formula, for example, to ensure the formula has a proper flavor intensity and viscosity when it is delivered from the package.

In some embodiments, the formula may include antioxidants to prevent lipid oxidation during shelf life. Examples of such antioxidants include BHA, BHT, propyl gallate, and tocopherols.

TABLE 1 illustrates example ranges for ingredients of a flavored, dairy-based formula formulation.

TABLE 1
Flavored Dairy Formula

| Ingredient | Range |
|---|---|
| Butterfat | 0-40% |
| Skim Milk | 10-40% |
| Milk Solids Nonfat | 0.2-5% |
| Stabilizers | 1-5% |
| Cellulose Gum/Gel | Up to 1% |
| Buffering Salt | Up to 1% |
| Emulsifiers | Up to 5% |
| Flavors | Variable |
| Water | Remainder |
| Antioxidants | Up to 0.1% |
| Sugar | 7-50% |

TABLE 2 illustrates example ranges for ingredients of an unflavored, dairy-based formula formulation.

TABLE 2
Unflavored Dairy Formula

| Ingredient | Range |
|---|---|
| Butterfat | 0-40% |
| Milk | 50-85% |
| Milk Solids Nonfat | 1-9% |
| Stabilizers | 1-5% |
| Cellulose Gum/Gel | Up to 1% |
| Buffering Salt | Up to 1% |
| Emulsifiers | Up to 2% |
| Flavors | Variable |
| Water | Remainder |
| Antioxidants | Up to 0.1% |
| Bulking Agent | Up to 20% |
| Sugar | 1-10% |

TABLE 3 illustrates example ranges for ingredients of a flavored, non-dairy based formula formulation.

TABLE 3
Flavored Non-Dairy Formula

| Ingredient | Range |
|---|---|
| Water | 30-50% |
| Vegetable Oil | 2-40% |
| Sodium Caseinate | Up to 2% |
| Stabilizers | 1-5% |
| Cellulose Gum/Gel | Up to 1% |
| Buffering Salt | Up to 1% |
| Emulsifiers | Up to 2% |
| Flavors | Variable |
| Water | Remainder |
| Antioxidants | Up to 0.1% |
| Salt | Up to 0.5% |
| Sugar | 7-50% |

TABLE 4 illustrates example ranges for ingredients of an unflavored, non-dairy based formula formulation.

TABLE 4
Unflavored Non-Dairy Formula

| Ingredient | Range |
|---|---|
| Water | 40-80% |
| Vegetable Oil | 2-40% |
| Sodium Caseinate | Up to 2% |
| Stabilizers | 1-5% |
| Cellulose Gum/Gel | Up to 1% |
| Buffering Salt | Up to 1% |
| Emulsifiers | Up to 2% |
| Flavors | Variable |
| Water | Remainder |
| Antioxidants | Up to 0.1% |
| Salt | Up to 0.5% |
| Sugar | 2-10% |
| Bulking Agents | Up to 20% |

Embodiments of the disclosure may provide numerous advantages. According to some embodiments, a package system may be used to create a cappuccino-type beverage in the home. The easy, no-mess, one-step solution creams and may also flavor the coffee while creating a head of foam reminiscent of coffeehouse steamed milk. The amount of creaming and foam can be dosed to levels that provide customization for the individual. Some, none, or all embodiments may benefit from the described advantages. Other technical advantages will be apparent to one of skill in the art.

Modifications, additions, or omissions may be made to system 10 without departing from the scope of the invention. The components of system 10 may be integrated or separated. Moreover, the operations of system 10 may be performed by more, fewer, or other components. Additionally, operations of system 10 may be performed using any suitable element. For example, in some embodiments, a separate chamber package, an independent dispenser package, an adjustable flow rate package, or other package may be used to produce a cream and foam.

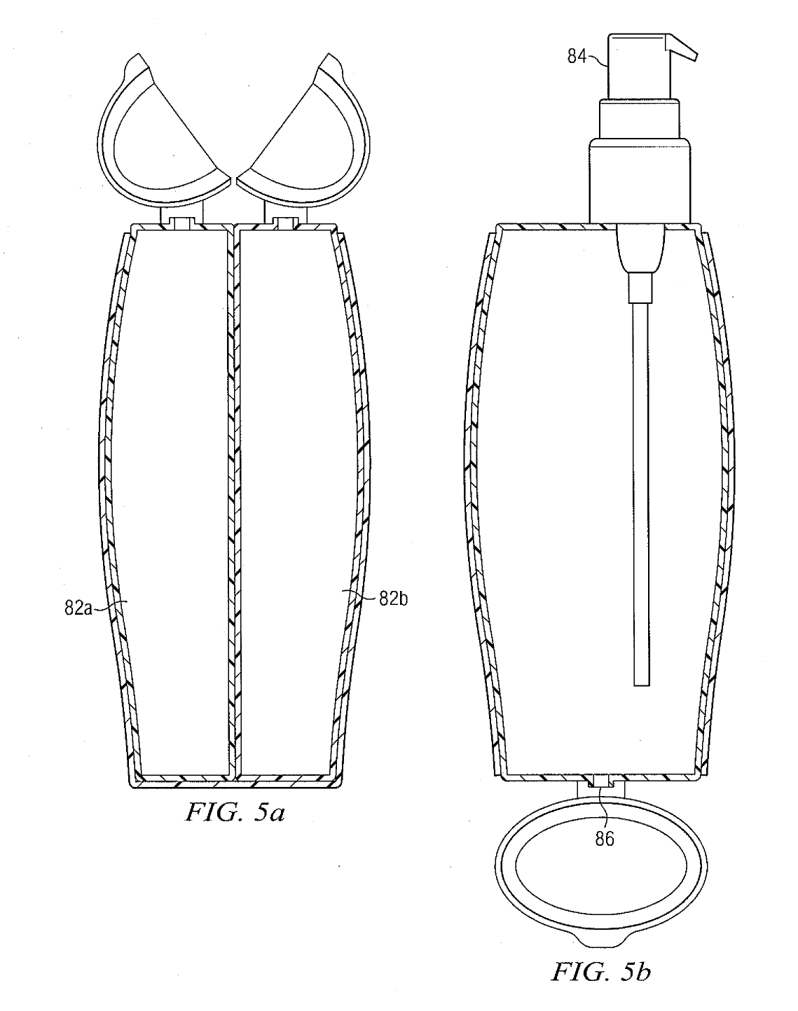

A separate chamber package may include a first chamber for dispensing a creaming formula and a second chamber for dispensing a foaming formula. In some embodiments, the creaming formula may be a powder, liquid, or tablet creamer or flavorant, and the foaming formula may comprise a liquid. The cream and foam may be formed through interaction with the package. For example, each chamber may include a suitable dispenser for dispensing formula in the selected form. Alternatively, the formula of one chamber may be selected to yield a creaming and/or foaming reaction when combined with the formula of another chamber, for example, upon dispensing the formulas into a liquid. That is, the creaming and foaming may be formed using chemical leavening. FIG. 5a illustrates an example of a package comprising separate chambers. In the example, the package comprises a first chamber 82a and a second chamber 82b.

An independent dispenser package may include multiple dispensers that independently dispense a formula from a single chamber. A first dispenser may dispense a portion of the formula as a creamer that may substantially disperses throughout a liquid, such as coffee. In some embodiments, the first dispenser may comprise a pourable or squeezable dispenser or a pump. A second dispenser may dispense a portion of the formula substantially in a foam form that may float substantially on the liquid's surface. In some embodiments, the second dispenser may comprise a pump. In some embodiments, the dispensers may be combined in a multi-purpose nozzle. FIG. 5b illustrates an example of an independent dispenser package. In the example, the package comprises a pump dispenser 84 and a squeezable dispenser 86.

An adjustable flow rate package may include a dispenser that allows for controlling the flow rate at which the formula evacuates the package. For example, the dispenser may dispense the formula at a first flow that disperses the formula throughout a liquid and at a second flow rate that causes the formula to form a foam substantially on the surface of the liquid. In some embodiments, the dispenser may comprise a nozzle with multiple holes. In some embodiments, the dispenser may comprise a two-stage nozzle.

In some embodiments, the package may mix a separate gas with the formula as the formula is dispensed. For example, the package may comprise a bag-on-valve dispenser or a gas cartridge. The formula may comprise a food formula, such as a dairy or non-dairy creamer, or a food and gas emulsion. Mixing the formula with a separate gas as the formula is dispensed may expand the formula and/or generate turbulence suitable to cream and foam a liquid.

Modifications, additions, or omissions may be made to the packages and products described herein without departing from the scope of the invention. For example, the functions described may be performed by more, fewer, or other components. Modifications, additions, or omissions may be made to the methods described herein without departing from the scope of the invention. The methods may include more, fewer, or other steps. Additionally, steps may be performed in any suitable order.

Although embodiments of the disclosure have been described using specific terms, such description is for illustrative purposes only. The words used are words of description rather than of limitation. It is to be understood that changes and variations may be made by those of ordinary skill in the art without departing from the spirit or scope of the present disclosure, which is set forth in the following claims. Therefore, the spirit and scope of the appended claims should not be limited to the description of the embodiments disclosed therein.

What is claimed:

1. A system, comprising:
a formula comprising at least one foaming agent; and
a package for dispensing the formula, the package comprising an internal pressure selected to generate turbulence when the formula is dispensed into a liquid such that:
a first portion of the formula substantially disperses throughout the liquid; and
a second portion of the formula forms a foam on a surface of the liquid.

2. The system of claim 1, wherein the dispersing and foaming occurs substantially simultaneously as a result of the turbulence and independent of an additional step.

3. The system of claim 1, the internal pressure of the package within the range of approximately 30 to 160 pounds per square inch.

4. The system of claim 1, wherein the package contains one or more propellants operable to propel the formula from the package upon actuation, at least one of the one or more propellants including nitrous oxide, nitrogen, or carbon dioxide.

5. The system of claim 1, wherein the package comprises an aerosol package made of a polymer-based material.

6. The system of claim 1, wherein the package comprises a stem operable to dispense the formula, the stem having a diameter in the range of 0.02 to 0.375 inches.

7. The system of claim 1, wherein the formula comprises one or more other ingredients, at least one of the one or more other ingredients including a dairy creamer, a non-dairy creamer, or a flavor.

8. The system of claim 1, wherein the formula includes:
one or more emulsifiers, the one or more emulsifiers comprising up to approximately 5% of the formula; and
one or more stabilizers, the one or more stabilizers comprising approximately 1 to 5% of the formula.

9. The system of claim 1, wherein the foam comprises:
an overrun of 10 to 600%;
a stability of 1 to 30 minutes; and
an air cell size of 1 to 250 micrometers.

10. A package, comprising:
an aerosol dispenser; and
a container member operable to contain:
a formula; and
one or more substantially non-flammable propellants for propelling the formula from the package upon actuation.

11. The package of claim 10, wherein at least one of the propellants includes nitrous oxide, nitrogen, or carbon dioxide.

12. The package of claim 10, wherein the container member comprises a polymer-based material.

13. The package of claim 10, wherein the container member comprises a metal material.

14. The package of claim 10, wherein the formula comprises a dairy creamer, a non-dairy creamer, or whipped cream.

15. The package of claim 10, wherein the container further comprises a base, the base including a pushed up area and a standing ring, the diameter of the standing ring approximately 80% of the diameter of the package.

16. A package comprising:
a first chamber operable to dispense a creaming formula that, when applied to a liquid, disperses substantially throughout the liquid; and
a second chamber distinct from the first chamber, the second chamber comprising a dispenser operable to dispense a foaming formula that, when applied to the liquid, forms a foam substantially on a surface of the liquid.

17. The package of claim 16, the creaming formula comprising a powder, a liquid, a gel, or a tablet.

18. A package comprising:
a container member operable to contain a formula;
a first dispenser operable to dispense a first portion of the formula such that, when applied to a liquid, the first portion disperses substantially throughout the liquid; and
a second dispenser operable to dispense a second portion of the formula substantially in a foam form such that, when applied to the liquid, the foam floats substantially on a surface of the liquid.

19. The package of claim 18, wherein the first dispenser comprises a pourable or squeezable dispenser and the second dispenser comprises a pump.

20. A package comprising:
a first chamber containing a first formula; and
a second chamber containing a second formula, the second formula selected to yield a reaction when combined with the first formula and a liquid, wherein the reaction:
disperses a portion of the first formula and the second formula substantially throughout the liquid; and
generates a foam substantially on a surface of the liquid.

21. A package, comprising;
a container member operable to contain a formula; and
a dispenser operable to dispense the formula from the container member, the dispenser having an adjustable flow rate operable to dispense the formula at a first flow rate and a second flow rate, wherein:
the first flow rate dispenses the formula such that, when applied to a liquid, the formula disperses substantially throughout the liquid; and
the second flow rate dispenses the formula such that, when applied to a liquid, the formula forms a foam substantially on a surface of the liquid.

22. A package, comprising;
a container member operable to contain a formula;
an aerosol dispenser operable to mix a gas with the formula as the formula evacuates the package, the gas mixed at a pressure that generates turbulence when the formula is dispensed into a liquid such that:
a first portion of the formula substantially disperses throughout the liquid; and
a second portion of the formula forms a foam on a surface of the liquid.

23. A package, comprising:
an aerosol valve operable to dispense a substantially continuous flow of a formula-propellant emulsion when actuated;
a lever comprising a handle that projects from the package, the lever operable to actuate the aerosol valve when pressed; and
a lock-out feature, the lock-out feature operable to prevent actuation when locked.

24. The package of claim 23, wherein the lock-out feature comprises an overcap, the overcap operable to prevent the lever from being pressed when locked.

25. The package of claim 23, wherein the lever comprises a toggle switch operable to lock and unlock the lock-out feature.

26. The package of claim 23, wherein the lock-out feature comprises an overcap and further comprising break-away tab tamper evidence, the break-away tabs traversing less than one-half of the perimeter defined by the overcap.

27. The package of claim 23, wherein the package comprises tear-off ring tamper evidence, the tear-off ring having a non-threaded fit, the tear-off ring anchored to the lever.
